(19) United States
(12) Patent Application Publication
(10) Pub. No.: US 2006/0177735 A1
(43) Pub. Date: Aug. 10, 2006

(54) Partition wall for a bipolar battery, bipolar electrode, bipolar battery and method for producing a partition wall

(76) Inventors: Ove Nilsson, Kungalv (SE); Britta Haraldsen, Horten (NO); Goran Dahlstrom, Borlange (SE)

Correspondence Address: JACOBSON HOLMAN PLLC, 400 SEVENTH STREET N.W., SUITE 600, WASHINGTON, DC, 20004, US

(21) Appl. No.: 10/547,345

(22) PCT Filed: Mar. 1, 2004
(86) PCT No.: PCT/SE04/00274

§ 371 Date: Sep. 1, 2005

(30) Foreign Application Priority Data
Mar. 4, 2003 (SE) 0300566-7

(51) Int. Cl. H01M 2/08; H01M 4/68; H01M 10/18; B32B 5/16

(52) U.S. Cl. 429/185; 429/245; 429/210; 29/623.2; 428/192; 428/328

(57) ABSTRACT

A partition wall for an electrode in a bipolar battery is comprised of a dimensional stable porous disc (1) of an electrically non-conductive material, the pores of which are filled with lead or a corresponding metal or an alloy thereof. The partition wall is distinguished by the porous disc at its peripheral region on at least one side being provided with an electrolyte-tight sealing edge portion (2) which is bound directly against the electrically non-conductive material in the porous disc, and that the material in the sealing edge portion includes any material from the group: glass, ceramic material, enamel, glazing, plastic or rubber. The invention also includes a bipolar electrode, a bipolar battery and a method for producing a partition wall.

### FIELD OF THE INVENTION

The invention concerns an intermediate partition wall for a bipolar battery according to the preamble of claim 1, a bipolar electrode including such a partition wall, a bipolar battery and a method of producing such a partition wall.

### BACKGROUND OF THE INVENTION

Bipolar batteries are previously known and are comprised of a number of series connected bipolar electrodes arranged in piles. Each pile is typically terminated at the one end of a positive monopole electrode with a current outlet and in the other end with a negative monopole electrode with a current outlet.

Between each bipolar electrode there is placed a separator, which is intended to prevent short circuiting in the pile and to contain a certain amount of electrolyte in order to ensure a passage of ions between the electrodes and—in case where the electrolyte participates in the cell reaction—ensure a certain capacity. In a previously known bipolar battery there is arranged a valve at each cell in order to prevent that a too high gas pressure is formed within the cell.

The bipolar electrodes consist of an electron conducting part (the partition wall) and at each side of this partition wall positive active material, e.g. PbO₂ and negative active material, e.g. porous Pb in case of a lead battery.

The partition wall can in principle be comprised of any electron conducting material, but certain demands are put on the material such as good electron conducting properties per unit weight and volume, good mechanical strength, good strength against corrosion and further the ability of making good contact with the active materials. The latter demand is met by lead, whereas lead is considered to be less advantageous when it comes to the other properties.

Several patent documents therefore describe combinations of lead with polymeric materials which are arranged so that a sufficient conduction is achieved with lead components positioned in the polymer and strength being aimed at with the aid of the polymer.

The use of organic materials (polymers) is, however, less suitable, in particular in lead batteries, since they tend to disintegrate while forming CO₂ in contact with oxygen and/or PbO₂, which has a detrimental effect on the ability of the battery to work maintenance-free. Further, a combination of lead and plastic results in the yielding of the plastic material when it is subjected to the pressure of a growing PbO₂ layer on the lead components at repeated charging and discharging of the battery, whereby leakage could result over or passed the partition wall.

A leakage in a bipolar cell, i.e. a liquid connection between one side of a bipolar electrode to the other side, results in creeping currents having the same effect as a short circuit and leads to self-discharge. Such a liquid connection could be a crevice in the partition wall or a capillary which has occurred because of incomplete lead infiltration. In such a case, however, the electrolyte will remain inside the battery.

Leakage can also occur at the frames that surround each bipolar electrode. Such a leak is particularly serious since the space between two bipolar electrodes may be emptied from electrolyte.

A first condition for a sealing between the frames is that the sealing surface can resist an attack from acid and oxidizing compounds (PbO₂, O₂). The surface must be free from deposits of substances that can corrode and thereby give rise to channels. For that reason, for example, a porous ceramic material having infiltrated lead cannot durably be used as a sealing surface.

According to U.S. Pat. No. 5,510,211 the bipolar partition wall is comprised of a porous disc of glass or a ceramic material which is chemically stable in the sense that it is not attacked by either PbO₂ or oxygen gas. The pores of the partition wall have been filled with lead or a lead alloy such that the electron conducting ability is sufficient for the purpose, whereas at each side of this mechanically stable bipolar electrode, active material has been deposited.

Infiltration of lead into the porous disc can be accomplished through electro-chemical plating or by filling the pores with molten lead. The ceramic material is sufficiently strong to withstand the volume increase that occurs at the oxidation of the lead to PbO₂ through corrosion. The formation of corrosion products increases the pressure between lead and the pore walls of the ceramic material, whereby the subsequent corrosion of the lead will be considerably reduced.

The dimension-stable partition wall according to U.S. Pat. No. 5,510,211 has to be attached inside the battery in such a way that there is no electrolyte contact by-passing or through the partition wall.

From U.S. Pat. No. 4,124,746 is previously known that the porous partition wall can be manufactured from titanium, zirconium or another similar material. The pores in said partition wall are filled with lead in such a way that a good electronic contact is achieved between metallic titanium and lead. In order to achieve a good seal between adjacent electrodes, there is arranged at the peripheral region of the disc a non-porous ring or a non-porous disc of the same material as the porous disc. Hereby a sealing ring of rubber can be mounted between the bipolar electrodes and provide sealing.

According to U.S. Pat. No. 4,124,746 it is also known to provide a surface with a seal by compression of a portion of the material comprising the porous disc, preferably at the peripheral part, whereby the pore openings will become smaller. Another suggested method is to seal the pore openings at the upper and lower sides of the disc with a ceramic material and thereby arrange a sealing surface.

A sealing surface which has been covered with O-rings or the like cannot be leakage free over a longer period if this sealing surface contains lead. This is because lead will oxidize to PbO₂, which in turn will split loose possible plastic which has been positioned above the lead component.

### AIM AND MOST IMPORTANT FEATURES OF THE INVENTION

The aim of this invention is to avoid the drawbacks of the background art and in particular to provide an improved partition wall, a bipolar electrode, a bipolar battery construction such that a pile of bipolar electrodes inside a bipolar battery will become free from leakage.

This aim is obtained in a partition wall etc. according to the above through the features of the characterizing portion of claim 1 as well as of the other independent device claims.

Said partition wall according to the invention thus comprises a dimension-stable porous disc of a non-electrically conductive material having a sealing edge strongly bonded to the porous disc which is formed from glass, a enamel, glazing, ceramic material, a plastic material, a rubber material or the like. The pores of the disc are filled with or have been filled with lead, a lead alloy or a corresponding material.

It should be noted that what is said here with respect to lead is also relevant with respect to alloys with e.g. tin and calcium that are used in the lead battery technology in order to increase strength, handling, resistance against corrosion etc. of lead, which is well-known to the person skilled in the art.

According to the invention a bipolar battery is obtained which is free from leakage over the partition walls under a long series of working cycles. The connection of the sealing edge portion is made directly against the electrically non-conducting material in the porous disc, whereby the homogeneous and electrolyte-tight surface of the sealing edge is further used as abutment surface against further sealing means which will be described further below.

Through the invention it is obtained that leakage of electrolyte, and thereby leaking currents, through the partition walls in the resulting bipolar battery can be effectively avoided. The attachment through the strong bond of the sealing edge portion directly against the non-electric conducting material in the porous disc results in that the oxidation of the infiltrated lead cannot brake loose the sealing edge portion during cycling of the battery, whereby a durable seal can be maintained.

The outer surface of the electrolyte-tight sealing edge portion which is directed from the porous disc will subsequently form an excellent ground for attaching sealing elements of e.g. synthetic material by gluing, melt attaching, ultrasound welding etc.

By having the sealing edge portion surrounding the peripheral part of the porous disc and forming an essentially U-shaped section, advantageous, widely extending sealing is achieved and the possibility of a very safe attachment of further sealing elements to the surrounding sealing edge portion.

By having the sealing edge portion positioned and being attached to only one side of the porous disc manufacture is simplified, since the material which is intended to form the sealing edge portion only has to be supplied to the porous disc from one direction. The infiltration of lead and the like is also simplified.

It is preferred that the porous disc includes a ceramic material since this result in good form-stability and rational and economic manufacture. In particular, these properties are achieved when the ceramic material is sintered.

By the porosity of the porous disc being about 5-30% is a preferred good adjustment of resulting low weight and stability is achieved. In particular it is preferred that the porosity is about 10-20%.

When the coefficient of thermal expansion of the porous disc corresponds to the coefficient of thermal expansion of the material in the sealing edge portion, it is achieved that temperature fluctuations will not result in thermally effected tensions in the material, which could risk creating the formation of crevices of the like. This is of course relevant in case the sealing edge is comprised of an essentially rigid material.

It is preferred that the sealing edge portion has a thickness of about 0.1-1.0 mm, which gives a condition for good sealing and mechanical properties of the sealing edge portion.

According to a preferred aspect of the invention, the sealing edge portion is attached to the material of the porous disc before it is filled with lead or a corresponding material. This gives better conditions for excellent attachment but requires that the material in the sealing edge portion and possible attachment agent is not negatively affected at the infiltration of lead in the pores. For example, it is required that the melting point is higher than the temperature of the lead intended for infiltration.

According to another aspect of the invention, however, the sealing edge portion is attached and fastened to the porous disc after the latter having been infiltrated with lead or a corresponding material. In this aspect, material with a lower melting point can be used, for example plastic materials and rubber materials. In this aspect, it is required with respect to the attachment of the sealing edge portion, that the material of the porous disc is thoroughly freed from lead or the corresponding material over a considerable portion of the peripheral part/parts of the disc. This can be achieved through thorough grinding, but also other methods can be implemented such as for example scraping. The sealing edge portion is subsequently formed by applying an organic or inorganic material, which bonds well against the material of the disc. An example of such a material is rubber which is vulcanized against the porous material or Santoprene® or the like. A further advantage of this aspect is that the sealing edge portion which is applied this way can constitute and, thus, replace the above mentioned additional sealing elements such as sealing frames.

By the partition wall, comprising a sealing frame which surrounds the porous disc and its peripheral portion, and which is electrolyte-tightly applied to the sealing edge portion, the possibility of achieving a good seal of a resulting battery pile is achieved. When, in particular, the sealing frame includes at least two surrounding frame portions of different synthetic materials being attached to each other in an electrolyte-tight manner, whereof one first frame portion is attached to the sealing edge portion and a second frame portion provides sealing surfaces for sealing co-operation with sealing frames of adjacent partition walls, it is provided provisions for adaptation of the different portions of the sealing frame to different functional demands and conditions. In particular the material in the first frame portion is more elastic than in the second frame portion for adaptation of the sealing properties and the attachment properties, respectively.

The invention also concerns a bipolar electrode including a partition wall according to the invention and a bipolar battery including at least one such electrode. Hereby the corresponding advantages are achieved as with respect of the partition wall.

The invention also concerns a method for manufacturing a partition wall according to the invention whereby corresponding as well as further advantages are achieved.

By, in a preferred method for forming the sealing edge portion onto the porous disc, applying a partial layer of glass powder in a paste or a slurry which is dried and sintered so as to attach to the porous disc, an effective and rational manufacture as well as a strong bond to the material of the porous disc is achieved. Application of the paste or slurry through a printing technology step is particularly effective and economic.

### BRIEF DESCRIPTION OF THE DRAWINGS

The description of the invention will be made at the background of the annexed drawings, but this detailed description with drawings must only be considered as exemplary and does not comprise a limitation per se of the invention.

FIGS. 1a and 1b show in sections two different embodiments of partition walls according to the invention being comprised of ceramic discs with sealing edges,

FIGS. 2a, 2b and 2c show sections through partition walls according to the invention with sealing edges and frames,

FIG. 3 shows diagrammatically a bipolar battery and in more detail a bipolar electrode according to the invention, and

FIG. 4 shows in a section a further embodiment of a partition wall according to the invention.

### DESCRIPTION OF EMBODIMENTS

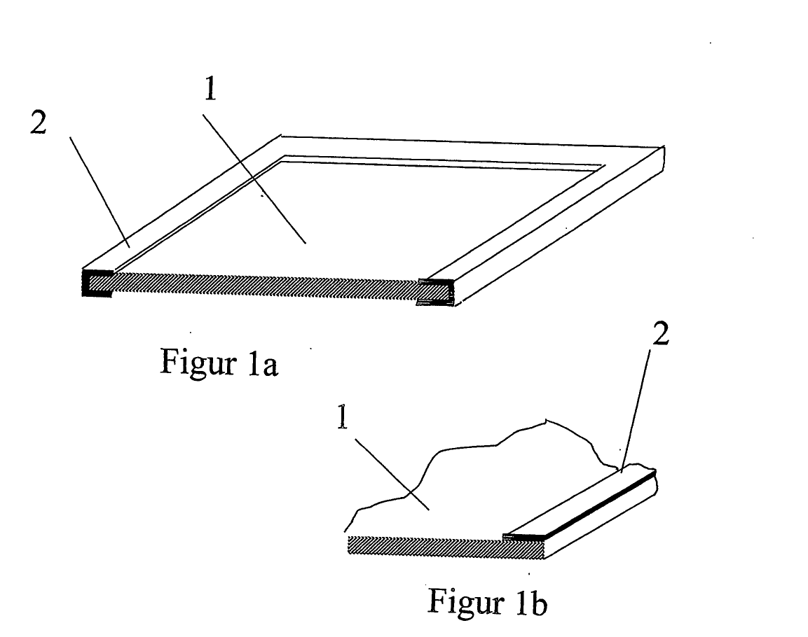

The partition wall which is shown in a section in FIG. 1a is comprised of a disc 1 of a porous, ceramic material having a sealing edge portion 2 of glass, ceramic material, enamel, glazing or the like. The partition wall is shown quadrangular but can with respect to its outer shape also be circular or have any other configuration. The thickness of the ceramic disc is suitably between 0.3 and 3 mm, preferably 0.75 to 1.0 mm, even if other dimensions can come into question.

In FIG. 1a a sealing edge portion 2 is shown surrounding the peripheral region of the porous disc, and this construction is preferred since it provides advantageous excellent properties with respect to sealing as well as attachment.

In a sintered porous disc of a ceramic material, the sealing edge portion is preferably of a glass material, which gives good attachment against the porous ceramic material as well as an outside surface which is well suited for attachment and fastening of a further sealing means in the form of a sealing frame.

In FIG. 1b there is shown another example of a partition wall, where the sealing edge portion 2 is attached peripherally on only one side of the disc 1. Also this embodiment gives good sealing properties to the resulting partition wall. An advantage with this construction is that the infiltration of lead or the similar into the pores of the disc is facilitated at the peripheral regions. The manufacturing process is also simplified since the starting material, for example slurry of glass powder in water, is applied from one single side of the porous disc. As further, not shown, embodiments, the sealing edge portion may be positioned on two sides of the peripheral region of the disc 1 or, which is not preferred, only at that side of the disc which is perpendicular to the main plane of the disc.

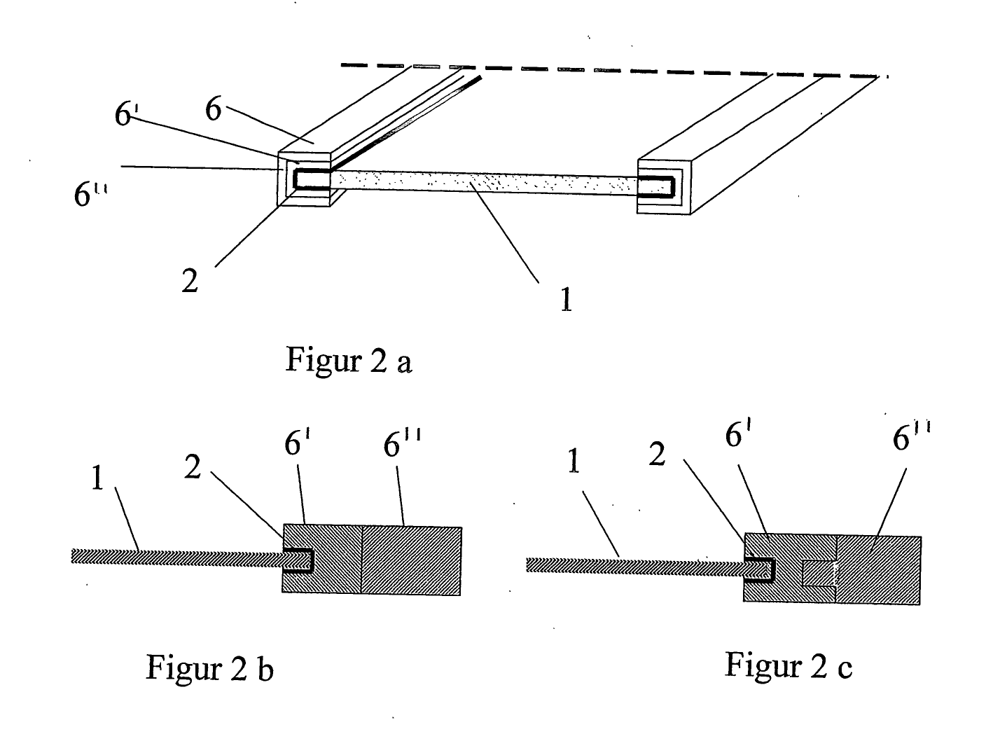

FIG. 2a shows a section through a partition wall with a porous ceramic disc 1 and a surrounding sealing edge portion 2. Further, a sealing 6 frame is shown which is applied to the ceramic disc after infiltration with lead or the like. The sealing frame here consists of two electrolyte-tightly joined, in section U-shaped, frame portions 6′ and 6″, whereof the first, 6′, is attached electrolyte-tightly at the sealing edge portion and surrounding the peripheral region of the disc 1, whereas the second electrolyte-tightly encloses the first and is adapted to lie electrolyte-tightly against and be fastened against a sealing frame of an adjacent partition wall. Examples of materials which can be used for the first frame portion is Santoprene which is completed with a primer for electrolyte-tight application against the sealing edge portion. The first frame portion is comprised of a softer polymer having a greater degree of elasticity than the second frame portion, which preferably is comprised of an extrudable and weldable thermoplastic material such as e.g. polypropylene or ABS. Variations of sealing frames are shown in FIGS. 2a and c, wherein the second frame portion 6″ lies only externally in a direction from the first frame portion 6′. In FIG. 2c the joining of the frame portions are secured through a groove in the one details and a suitable ridge in the other one.

Applying a polymer against a glass surface can be achieved through several ways that are known to the person skilled in the art. The glass surface which is to be adhered with a polymeric material should, however, be grounded with a primer for best result.

U.S. Pat. No. 5,510,211 describes how the pores of the ceramic material are infiltrated with lead all the way out to the peripheral region of the disc. The outer peripheral region will thus be inhomogeneous and be comprised of ceramic surfaces as well as lead surfaces. For this reason, a part of this disc which is coated with a polymer would split loose over time, since the lead under the polymer/primer would oxidize and increase its volume. In any case, acid and thereby current would find its way even through hair crack capillaries with porous PbO₂. According to the invention, on the other hand, the central portions of the disc 1 can be filled with lead and sealing agent of polymeric material with primer can be applied on the peripherally attached sealing edge portion 2 without any risk of splitting.

A surrounding polymeric frame can be provided with holes for tension rods (not shown) for mounting several electrodes with inventive partition walls together with end electrodes into a bipolar battery. In this case there could be positioned sealing rings or any other sealing between each bipolar electrode. Other embodiments that are possible and are made possible through the invention are direct welding together or gluing of several adjacent plastic frames so as to form a battery pile.

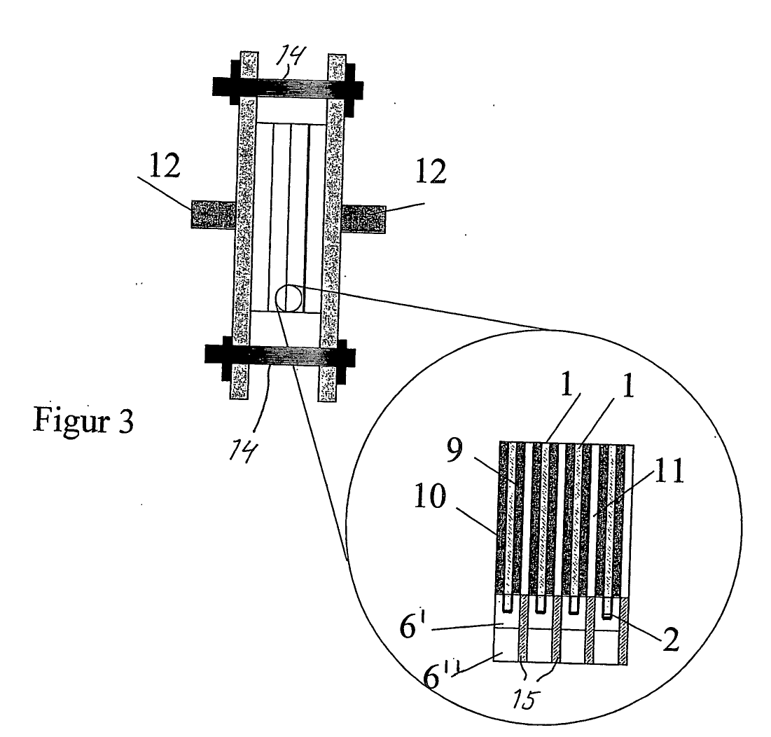

FIG. 3 shows diagrammatically and in detail a portion of a battery having bipolar electrodes, which each is comprised of a partition wall 1, positive active material 9, and negative active material 10. A frame 6 which is comprised of at least two different layers surrounds the partition wall 1. Tension rods 14 ensure pressure application on the battery pile. The sealing frames can be mutually directly weld-joined, for example through ultra-sound welding or be glued. Between the frames, sealing rings 15 can also be positioned for sealing purposes. Between each bipolar electrode there is as usual a separator 11 with electrolyte. The battery further includes a current terminal 12 and a housing (not shown).

A porous disc of ceramic material for use with the invention can be manufactured through for example pressing or sintering of a ceramic powder, preferably with well defined grading distribution. It is also possible to add pore formers of an organic material to a paste of ceramic particles. The mixture is formed to a disc, whereupon this disc is subjected to such a high temperature that water is evaporated, pore formers are gasified and the ceramic particles are sintered together. For ceramic materials the sintering temperature can be as high as 1500-2000° C. In a corresponding manner glass spheres can be sintered together and form a well integrated porous body. These methods are only to be regarded as examples of how the porous body can be manufactured and are not limiting the invention. The porous material thus preferably includes glass or ceramic materials such as in general Al₂O₃. It is, however, not excluded that other dimension-stable materials could be used.

In order to manufacture a partition wall according to the invention, the sintered porous disc, according to a preferred embodiment, is applied with a slurry of glass and water at a defined area at the peripheral region of the disc 1. The glass is molted through heating and provides a sealing edge portion 2 having a smooth, covering surface which is well attached and strongly bound against the porous material.

In order to achieve the greatest possible strength of the glass edge portion and the ceramic material it should be strived at to have the materials having the same or almost the same coefficient of thermal expansion. Through changes in the composition for firstly the material in the sealing edge portion (but also for the porous disc) good correspondence between the coefficients of thermal expansion can be achieved.

The porous ceramic disc with sealing edge portion is subsequently infiltrated with lead through dipping it into a lead melt under vacuum. Through combinations of pressure and vacuum the porous ceramic disc can be almost completely filled with lead. Before dipping, the sealing edge portion can be masked in order to prevent lead contamination.

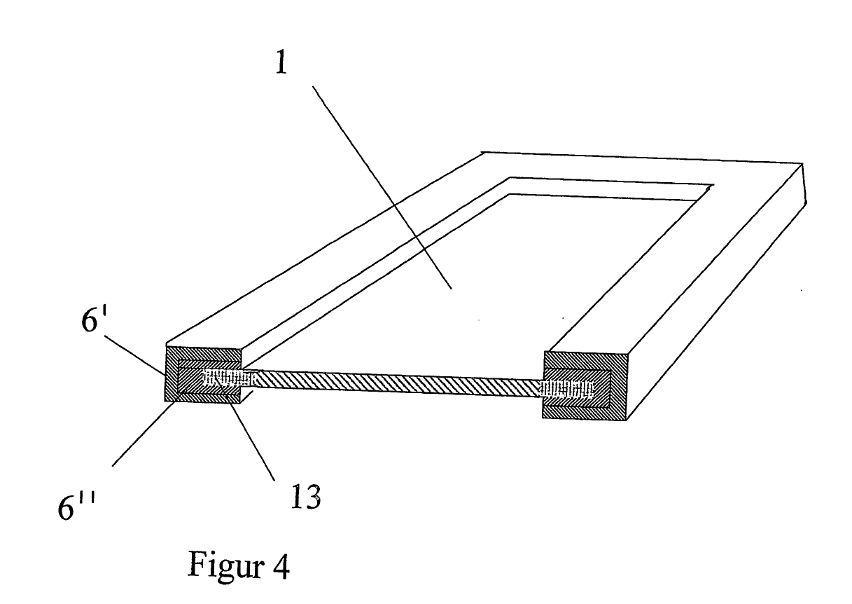

The above method presupposes that the sealing edge portion is comprised of a material having a higher melting point than the temperature of the lead intended for infiltration. In another aspect it is possible to apply a sealing edge of a material having a lower melting point (or a point where it is effected), which otherwise could risk to be destroyed at the infiltration process. This is realized in such a way that after infiltration with lead, which has been allowed to harden, all, or a great part of the lead in an edge region on the outside of the peripheral region of the disc (13 in FIG. 4) is removed, for example by grinding. Possibly this region is etched, for example with acetic acid and hydro-peroxide. Thereafter there is applied a material which binds well against the uncovered porous material for forming a sealing edge portion. Plastic materials can be glued with suitable glue. As is indicated above, this way further sealing elements could be avoided.

The lead-filled partition wall is then (if necessary) fastened inside a double sealing frame with the possibility of having several bipolar electrodes mounted after each other and being terminated with monopole end electrodes and, between each one of the electrodes, a mounted separator. A partition wall resulting from such a process is shown in FIG. 4, whereby the same references as above have been used in adequate parts.

The joining which can be made with high pressure can, besides tension rods, also be accomplished with bolts, through gluing or through welding.

Since gas can be formed in all cells, there should be a possibility of evacuation, possibly with a valve, and be applied to each cell (not shown). Alternatively an outer housing is allowed to surround the bipolar pile and be provided with an evacuation with a valve at the same time as each bipolar cell is in open connection with a gas space inside the housing.

When glass is intended to form the sealing edge portion, it can also be applied to the partition wall as a paste which is subsequently dried and sintered. The application of the paste or the slurry can be made through a method from the printing technology, for example through screen-printing which is well-known from thick film technology. The ceramic partition wall is covered with said paste to a width of 2-20 mm, preferably about 5 mm. An example of such a paste could be a heavy slurry of glass particles with such a composition that they can be sintered to a well fastened, covering and smooth surface. The thickness of a porous ceramic material and the applied sealing edge portion should after sintering be at the most 5 mm, whereof preferably the sealing edge portion itself about 0.1-1.0 mm and most preferably below 0.5 mm. The application of the slurry or the paste on the partition wall is made in the pattern which is to be maintained after sintering.

A further method of manufacturing a disc according to the invention is to protect the central portion of the disc with suitable material, for example a plate and wherein the not shielded outer portion and the edge of the ceramic disc is applied with an oxide through flame spraying. It could thereby not be expected that the applied material will penetrate the pores but more likely to be applied on the outside of the ceramic material and will provide a protective cover which, however, is well attached to the underlying porous material.

The plastic frame that adjoins to the partition wall is applied through extruding, molding or in any other way. A polymer is thereby directly bound to the material around the peripheral region and side edge of the ceramic disc. Another polymer is attached, before, simultaneously or later, onto the first polymer. It is, however, fully possible to form the plastic frame from one single material. Further it is possible to even more strengthen the bond between the plastic frame and the applied glass edge portion and thereby further reduce the risk of leakage by giving the glass edge portion a surface structure which is suitable for that purpose.

Besides the tight joint between porous material and sealing frame, which is provided according to the invention through a suitable choice of materials or the materials in the plastic frame, a construction will result which is relatively insensitive to vibrations and is shock absorbing. This shock absorbing effect is of importance in batteries for trucks, as start batteries in construction machines and, perhaps above all, in batteries for submarines which are exposed to depth charge attacks.

1. Partition wall for an electrode in a bipolar battery and being comprised of a dimensional stable porous disc of an electrically non-conductive material, the pores of which are filled with lead or a corresponding metal or an alloy thereof, characterized in
that the porous disc at its peripheral region on at least one side is provided with an electrolyte-tight sealing edge portion which is bound directly against the electrically non-conductive material in the porous disc, and
that the material in the sealing edge portion includes any material from the group: glass, ceramic material, enamel, glazing, plastic or rubber.

2. The partition wall according to claim 1, characterized in that the sealing edge portion surrounds the peripheral region of the porous disc and forms an essentially U-shaped section.

3. The partition wall according to claim 1, characterized in that the sealing edge portion is provided and is attached to only one side of the porous disc.

4. The partition wall according to claim 1, characterized in that the porous disc includes a ceramic material.

5. The partition wall according to claim 4, characterized in that the ceramic material is sintered.

6. The partition wall according to claim 1, characterized in that the porous disc includes a glass material.

7. The partition wall according to claim 1, characterized in that the porosity of the porous disc is about 5-30% and in particular about 10-20%.

8. The partition wall according to claim 1, characterized in that the coefficient of thermal expansion of the material in the porous disc corresponds to the coefficient of thermal expansion of the material in the sealing edge portion.

9. The partition wall according to claim 1, characterized in that the sealing edge portion has a thickness of about 0.1-1.0 mm.

10. The partition wall according to claim 1, characterized in that the sealing edge portion covers the peripheral region of the porous disc with a width of about 2-20 mm.

11. The partition wall according to claim 1, characterized in that the sealing edge portion is attached and fastened directly against the material in the porous disc before its pores are filled.

12. The partition wall according to claim 1, characterized in that the sealing edge portion is attached and fastened directly against the material in the porous disc after that its pores are filled.

13. The partition wall according to claim 1, characterized in that it includes a sealing frame which surrounds the porous disc and encloses its peripheral region and is electrolyte-tightly fastened to the sealing edge portion.

14. The partition wall according to claim 1, characterized in that the sealing frame includes at least two surrounding frame parts of different synthetic materials that are electrolyte-tightly joined to each other whereof a first frame portion is fastened to the sealing edge portion and a second frame portion provides surfaces for sealing co-operation with sealing frames of adjacent partition walls.

15. The partition wall according to claim 14, characterized in that the material in the first frame portion is more elastic than that in the second frame portion.

16. The bipolar electrode including a partition wall and active materials applied thereon, characterized in that it includes a partition wall according to claim 1.

17. The bipolar battery including a plural of bipolar electrodes, separators, electrolyte, current terminals and a housing, wherein at least one electrode is according to claim 16.

18. Method for manufacturing a partition wall of an electrode in a bipolar battery being comprised of a dimensional stable porous disc of an electrically non-conductive material, the pores of which being filled with lead or a corresponding metal or an alloy thereof, characterized in
that the porous disc at its peripheral region on at least one side is provided with an electrolyte-tight sealing edge portion which is fastened directly against the electrically non-conductive material in the porous disc, and
that the material that is used in the sealing edge portion includes any material from the group: glass, enamel, ceramic material, glazing, plastic or rubber.

19. The method according to claim 18, characterized in that the sealing edge portion is fastened against the material in the porous disc before its pores are filled.

20. The method according to claim 19, wherein the porous disc is comprised of a sintered ceramic material, and wherein a sealing edge portion of glass is to be applied, characterized in that for forming the sealing edge portion a partial layer of glass powder in a paste or a slurry is applied on the porous disc, and is dried and sintered together with the porous disc.

21. The method according to claim 20, characterized in that said paste or slurry is applied through a printing technology step.

22. The method according to claim 18, characterized in that the sealing edge portion is fastened to the material in the porous disc after that its pores have been filled.

23. The method according to claim 22, characterized in that an excess of filling material is removed from a peripheral region of the porous disc, whereupon a rubber material, which is intended to comprise the sealing edge portion, is attached through vulcanizing onto the material of the porous disc.
